(19) United States
(12) Patent Application Publication
(10) Pub. No.: US 2023/0102402 A1
(43) Pub. Date: Mar. 30, 2023

(54) CONNECTOR ASSEMBLY, MALE CONNECTOR, FEMALE CONNECTOR AND USE IN BUILDING COMPONENTS

(71) Applicant: United States of America as Represented by The Secretary of the Army, Alexandria, VA (US)

(72) Inventor: Tanner J. Wood, Champaign, IL (US)

(21) Appl. No.: 17/488,824

(22) Filed: Sep. 29, 2021

(51) Int. Cl. F16B 7/04; E04B 1/41

(52) U.S. Cl. CPC F16B 7/0426; E04B 1/40

(57) ABSTRACT

The disclosure relates to a connector assembly including a male connector and a female connector that are connectable to each other. The male connector includes a connector main body having an annular shape and a plurality of male nubs arranged circumferentially around the connector main body, each male nub configured to be received by a corresponding female slot. The female connector includes a main body portion having an annular shape and a plurality of female slots arranged circumferentially around the main body portion, each female slot configured to receive a corresponding male nub. The male connector and female connector are configured such that when the male connector is connected to the female connector, the plurality of male nubs engages with respective ones of the plurality of female slots. The connector system is particularly applied to link building components together to form structural elements.

### GOVERNMENT INTEREST

The subject matter of this disclosure was made with support from the United States Army Corps of Engineers—Engineer Research and Development Center, Construction Engineering Research Laboratory. The Government of the United States of America has certain rights in this invention.

### TECHNICAL FIELD

The present disclosure relates to a connector assembly, including a male connector and corresponding female connector, which is used to connect two components. In particular, the connector system is used with structural components or building components in various ways for use in building a structure, such as a modular structure.

### BACKGROUND

Known modular structures, framing systems, and structural components often include assembly processes that require power tools or specialty tools and complex assembly processes. In addition, some modular structures, framing systems, and structural components are not releasably attached such that the components cannot be quickly and handily disassembled and/or additional components attached to an existing structure. Modular structures, framing systems, and structural components must also prove to have suitable resistance to mechanical stresses.

There exists a need for modular structures, framing systems, and structural components that improve upon and address these issues.

### SUMMARY

One aspect of the present disclosure is directed to a connector assembly that includes a male connector and a female connector that are connectable to each other. The male connector has a connector main body having an annular shape and a plurality of male nubs arranged circumferentially around the connector main body, each male nub configured to be received by a corresponding female slot. The female connector has a main body portion having an annular shape and a plurality of female slots arranged circumferentially around the main body portion, each female slot configured to receive a corresponding male nub. The male connector and female connector are configured such that when the male connector is connected to the female connector, the plurality of male nubs engages with respective ones of the plurality of female slots.

Another aspect of the present disclosure is directed to a male connector that is connectable to a female connector that has a main body portion having an annular shape and a plurality of female slots arranged circumferentially around the main body portion, each female slot configured to receive a corresponding male nub. The male connector has a connector main body having an annular shape and a plurality of male nubs arranged circumferentially around the connector main body, each male nub configured to be received by a corresponding female slot. The male connector is configured such that when the male connector is connected to the female connector, the plurality of male nubs engages with respective ones of the plurality of female slots.

Another aspect of the present disclosure is directed to a female connector that is connectable to a male connector that has a connector main body having an annular shape and a plurality of male nubs arranged circumferentially around the connector main body, each male nub configured to be received by a corresponding female slot. The female connector has a main body portion having an annular shape and a plurality of female slots arranged circumferentially around the main body portion, each female slot configured to receive a corresponding male nub. The female connector is configured such that when the female connector is connected to the male connector, the plurality of male nubs engages with respective ones of the plurality of female slots.

A further aspect of the present disclosure is directed to building components for use in building a structure. A pair of the building components include a first building component having a male connector, the male connector having a plurality of male nubs arranged in a circular manner, each male nub configured to be received by a corresponding female slot, and a second building component having a female connector, the female connector having a plurality of female slots arranged in a circular manner, each female slot configured to receive a corresponding male nub. The male connector and female connector are configured such that when the male connector is connected to the female connector, the plurality of male nubs engages with respective ones of the plurality of female slots, thereby connecting the pair of building components.

Other features and advantages of the present disclosure will be apparent from the following description of the drawings and detailed description, which should not be construed as limiting the disclosure.

### BRIEF DESCRIPTION OF THE DRAWINGS

The objects, features and advantages of the present disclosure will become more apparent from the following detailed description, which proceeds with reference to the accompanying figures.

FIG. 1A is a perspective view of a male connector, according to an embodiment.

FIG. 1B is a top view of the male connector depicted in FIG. 1A, according to an embodiment.

FIG. 2A is a perspective view of a female connector, according to an embodiment.

FIG. 2B is a top view of the female connector depicted in FIG. 2A, according to an embodiment.

FIG. 3 is a perspective view of a male connector, according to an embodiment.

FIG. 4 is a perspective view of a female connector, according to an embodiment.

FIG. 5A is a top view of a full radial array of a male connector, according to an embodiment; FIG. 5B is a schematic top view of a single radial unit (SRU) of the male connector depicted in FIG. 5A; FIG. 5C is a schematic cross-section view through A-A of the SRU depicted in FIG. 5B. FIG. 5D is a perspective view of a SRU of a male connector, according to an embodiment.

FIG. 6A is a top view of a full radial array of a female connector, according to an embodiment; FIG. 6B is a schematic top view of a SRU of the female connector depicted in FIG. 6A; FIG. 6C is a schematic cross-section view through A-A of the SRU depicted in FIG. 6B. FIG. 6D is a perspective view of a SRU of a female connector, according to an embodiment.

FIGS. 7A, 7B, and 7C are perspective views of connector assemblies, male connectors, and female connectors, according to various embodiments.

FIG. 8 is an illustration of a connector system used in conjunction with building components, according to an embodiment.

FIG. 9 is an illustration of a connector system used to link building components together to form structural components, according to an embodiment.

### DETAILED DESCRIPTION

As used herein, the terms “and/or” as used herein means that two or more elements are to be taken together or individually. Thus, “A and/or B” and “A and or B” cover embodiments having element A alone, element B alone, or elements A and B taken together.

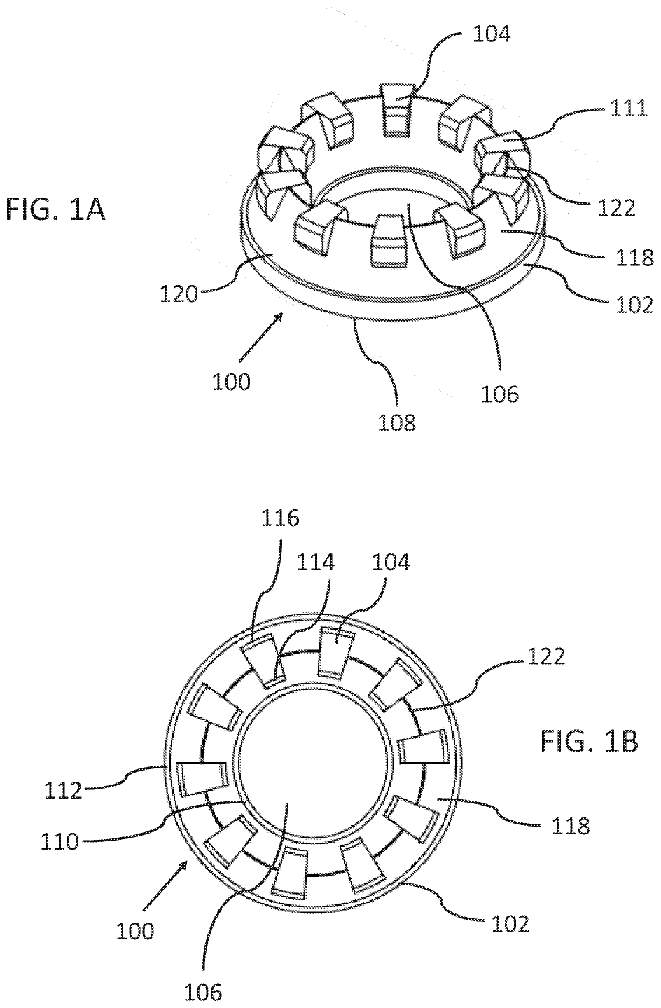

According to various embodiments of the present disclosure, a connector assembly includes a male connector and a female connector that are connectable to each other. Illustrated by the embodiments in FIG. 1A and FIG. 1B, the male connector 100 has a connector main body 102 having an annular shape and a plurality of male nubs 104 arranged circumferentially around the connector main body 100. Each male nub 104 is configured to be received by a corresponding female slot.

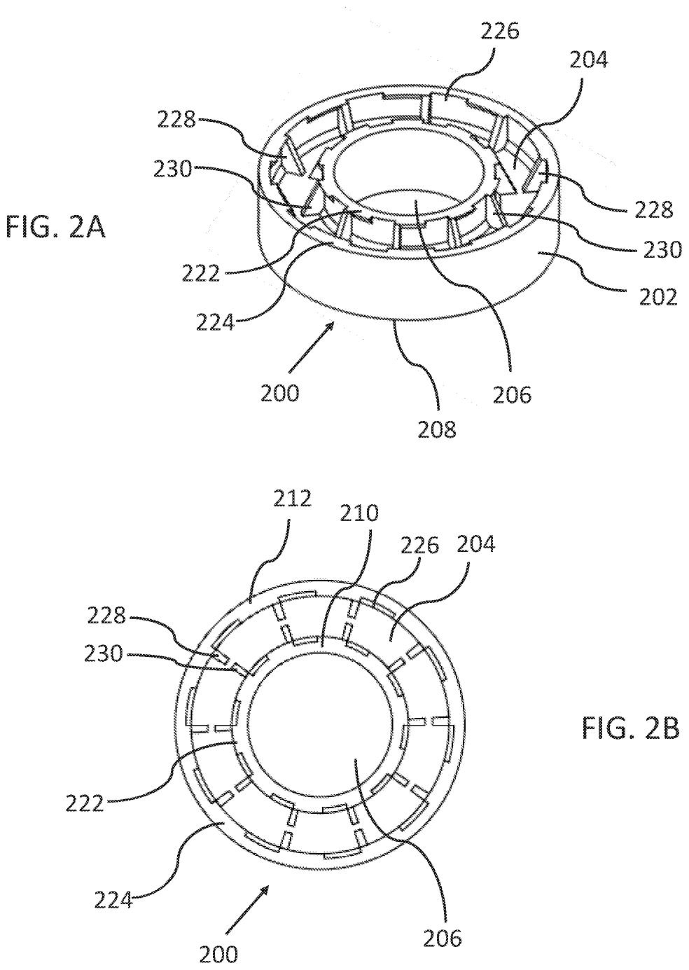

Illustrated by the embodiments in FIG. 2A and FIG. 2B, the female connector 200 has a main body portion 202 having an annular shape and a plurality of female slots 204 arranged circumferentially around the main body portion 202. Each female slot 204 is configured to receive a corresponding male nub 104. The male connector 100 and female connector 200 are configured such that when the male connector 100 is connected to the female connector 200, the plurality of male nubs 104 engages with respective ones of the plurality of female slots 204.

In various embodiments, the male connector 100 has a plurality of male nubs 104. In FIG. 1A, the embodiment has ten male nubs 104. Various embodiments of the male connector 100 have at least two and up to any number of male nubs 104, such as 2-50 or more male nubs 104. For example, various embodiments of the male connector 100 have eight, ten, twelve, sixteen, twenty, twenty-four, thirty-two, forty, or forty-eight male nubs 104.

In various embodiments, the female connector 200 has a plurality of female slots 204. In FIG. 2A, the embodiment has ten female slots 204. Various embodiments of the female connector 200 have at least two and up to any number of female slots 204, such as 2-50 or more female slots. For example, various embodiments of the female connector 200 have eight, ten, twelve, sixteen, twenty, twenty-four, thirty-two, forty, or forty-eight female slots 204.

In various embodiments of the connector assembly, the male connector 100 has an equal number of male nubs 104 as the female connector 200 has female slots 204. In other embodiments, the female connector 200 has more female slots 204 than the male connector 100 has male nubs 104.

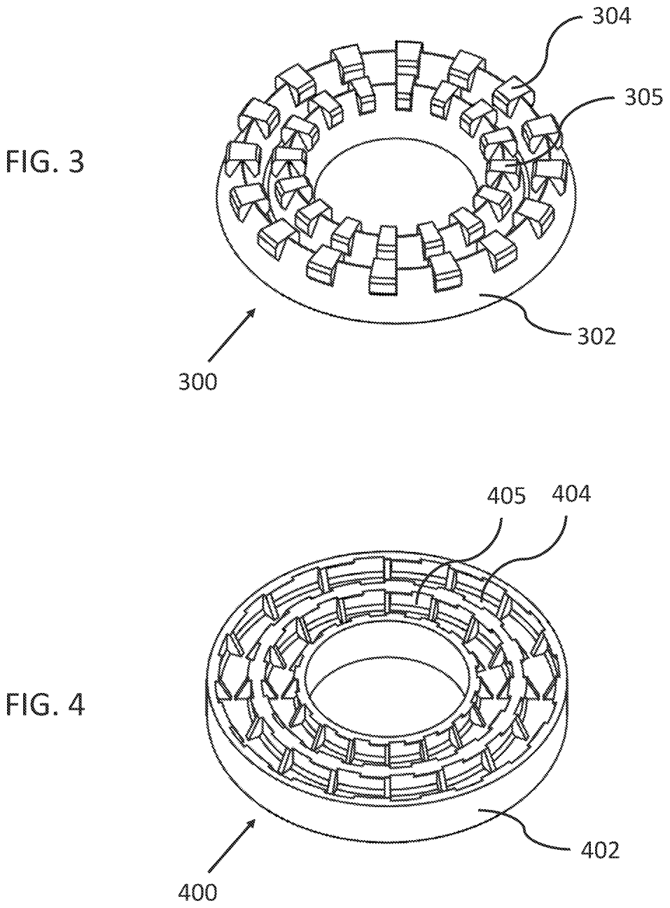

According to various embodiments of the connector assembly, the male connector has more than one set of male nubs. For example, as illustrated by the embodiment shown in FIG. 3, the male connector 300 has a first set of male nubs 304 arranged circumferentially around the connector main body 302 at a first radius, and a second set of male nubs 305 arranged circumferentially around the connector main body 302 at a second radius that is different than the first radius.

In various embodiments of the connector assembly, the female connector has more than one set of female slots. For example, as illustrated by the embodiment shown in FIG. 4, the female connector 400 has a first set of female slots 404 arranged circumferentially around the main body portion 402 at a first radius, and a second set of female slots 405 arranged circumferentially around the main body portion 402 at a second radius that is different than the rust radius.

According to various embodiments, at least one of connector main body 102 of the male connector 100 and the main body portion 202 of the female connector 200 has an inner hole 106, 206, respectively, that is a through-hole. In other embodiments, the inner portion of the annular shaped connector main body 102 or main body portion 202 is not a through-hole. In some embodiments, the bottom surface 108 of the male connector main body 102 and/or the bottom surface 208 of the female connector main body portion 202 covers the entirety of the bottom surface of the male connector 100 and/or female connector 200, respectively.

In various embodiments of the connector system, the male connector 100 has an annular shape, thus having a corresponding inner ring 110 and an outer ring 112. In various embodiments of the connector system, the female connector 200 has an annular shape, and thus a corresponding inner ring 210 and outer ring 212.

According to various embodiments, the male connector 100 includes male nubs 104 having a planar top surface 111. In various embodiments, the male nubs 104 have a trapezoidal shape along the planar top surface. As shown by the embodiment in FIG. 1A and FIG. 1B, male nubs 104 have a trapezoidal shape along the planar top surface 111 with a side 114 closest to the inner ring 110 shorter than a side 116 closest to the outer ring 112. The trapezoidal shape provides a tapering to the male nub 104.

According to various embodiments, the male connector 100 includes male nubs 104 distributed circumferentially around the connector main body 102 in a uniform manner, and each male nub 104 is separated by a substantially equal distance from one another.

According to various embodiments, the connector main body 102 of the male connector 100 has a tapered protrusion 118 protruding from the top surface 120 of the connector main body 102 and connecting to the male nubs 104. In various embodiments, the tapered protrusion 118 tapers on two sides of the protrusion, forming a triangular shaped protrusion. In some embodiments the angle of the taper on the two sides is the same and in some embodiments the angle of the taper on the two sides is different. In some embodiments, the tapered protrusion 118 between the male nubs 104 tapers to a point or substantially to a point 122. In other embodiments, the tapered protrusion 118 between the male nubs 104 tapers but retains a flat or substantially flat end having a determined width or thickness.

According to various embodiments of the connector assembly, the female slot 204 of the female connector 200 is configured to receive at least a portion of the tapered protrusion 118.

According to various embodiments, the connector assembly includes a locking mechanism configured to fix the male connector to the female connector. In some embodiments, the locking mechanism is configured to fix the male connector to the female connector in a permanent or substantially permanent or irreversible capacity. In other embodiments, the locking mechanism is configured to fix the male connector to the female connector in a non-permanent or reversible capacity. In a non-permanent capacity, the male and female connectors are fixed and connected and are reversibly un-fixed and disconnected or taken apart. In some embodiments, the locking mechanism is configured to fix the male and female connectors together when engaging the male nubs of the male connector with the female slots of the female connector and rotating the male connector with respect to the female connector.

According to various embodiments, the connector assembly includes a locking mechanism that has a plurality of inner flanges 222 arranged circumferentially around an inner ring 210 of the main body portion 202 of the female connector 200, and a plurality of outer flanges 224 arranged circumferentially around an outer ring 212 of the main body portion 202 of the female connector 200. The inner flange 222 and outer flange 224 together cover a portion of the female slot 204 but leave enough of the female slot 204 uncovered to form a receiving slot 226 that is open and configured to receive the male nub 104. The locking mechanism is configured such that when the male connector 100 is connected to the female connector 200 by engaging the male nubs 104 with the receiving slots 226, and rotating the male connector 100 with respect to the female connector 200, the male nubs 104 slide under and are held in place by the inner flange 222 and outer flange 224, engaging the locking mechanism and thereby fixing the male connector 100 to the female connector 200.

In various embodiments, the locking mechanism is configured to be reversible, and the male and female connectors can be disconnected and separated. To disconnect the locking mechanism, the male connector 100 is rotated with respect to the female connector 200 in an opposite direction to that used to engage the locking mechanism, the male nubs 104 slide back under the inner and outer flanges 222, 224 to the receiving slot 206, which is not covered by the inner and outer flanges 222, 224, thereby disengaging the locking mechanism. The male and female connectors can then be disconnected and taken apart.

According to various embodiments of the connector assembly, the female connector includes one or more stop barrier configured to work in conjunction with the locking mechanism. In various embodiments, the female connector 200 includes one or more outer stop barrier 228 positioned in the female slot 204 in proximity to an end of the outer flange 224 that is distal to the receiving slot 226. In other embodiments, the female connector 200 includes one or more inner stop barrier 230 positioned in the female slot 204 in proximity to an end of the inner flange 222 that is distal to the receiving slot 226. In some embodiments, the female connector 200 includes one or more outer stop barrier 230 and one or more inner stop barrier 228. The inner and/or outer stop barrier 228, 230 are each configured to engage with the male nub 104, thereby stopping the rotation of the male connector 100 at a location where the male nub 104 is under and held in place by the inner and outer flanges 222, 224.

According to various embodiments of the present disclosure, a male connector is connectable to a female connector that has a main body portion having an annular shape and a plurality of female slots arranged circumferentially around the main body portion, each female slot configured to receive a corresponding male nub. Illustrated by the embodiments in FIGS. 1A-1B and FIGS. 2A-2B, the male connector 100 has a connector main body 102 having an annular shape and a plurality of male nubs 104 arranged circumferentially around the connector main body 102, each male nub 104 configured to be received by a corresponding female slot 204. The male connector 100 is configured such that when the male connector 100 is connected to the female connector 200, the plurality of male nubs 104 engages with respective ones of the plurality of female slots 204.

According to various embodiments of the present disclosure, a female connector is connectable to a male connector that comprises a connector main body having an annular shape and a plurality of male nubs arranged circumferentially around the connector main body, each male nub configured to be received by a corresponding female slot. Illustrated by the embodiments in FIGS. 1A-1B and FIGS. 2A-2B, the female connector 200 has a main body portion 202 having an annular shape and a plurality of female slots 204 arranged circumferentially around the main body portion 202, each female slot 204 configured to receive a corresponding male nub 104. The female connector 200 is configured such that when the female connector 200 is connected to the male connector 100, the plurality of male nubs 104 engages with respective ones of the plurality of female slots 204.

In various embodiments, the female connector 200 includes a plurality of inner flanges 222 arranged circumferentially around an inner ring circumference 210 of the annular main body portion of the female connector, and a plurality of corresponding outer flanges 224 arranged circumferentially around an outer ring circumference 212 of the annular main body portion of the female connector. The inner flange 222 and outer flange 224 together cover a portion of the female slot 204 but leave the female slot 204 with a receiving slot 226 that is open and configured to receive the male nub 104. The inner flange 222 and outer flange 224 together form a locking mechanism configured such that when the male connector 100 is connected to the female connector 200 by engaging the male nubs 104 with the receiving slots 226, and rotating the male connector 100 with respect to the female connector 200, the male nubs 104 slide under and are held in place by the inner flange 222 and outer flange 224, engaging the locking mechanism and thereby fixing the male connector 100 to the female connector 200.

In various embodiments, the female connector includes one or more stop barrier. In embodiments, an inner stop barrier 228 is positioned in the female slot 204 at an end of the inner flange 222 distal to the receiving slot 226. In embodiments, an outer stop barrier 230 is positioned in the female slot 204 at an end of the outer flange 224 distal to the receiving slot 226. In some embodiments, the female connector 200 includes both inner stop barrier 228 and outer stop barrier 230. The one or more stop barrier is configured to work in conjunction with the locking mechanism, and to engage with the male nub 104, thereby stopping the rotation of the male connector 100 at a location where the male nub 104 is under and held in place by the inner and outer flanges 222, 224.

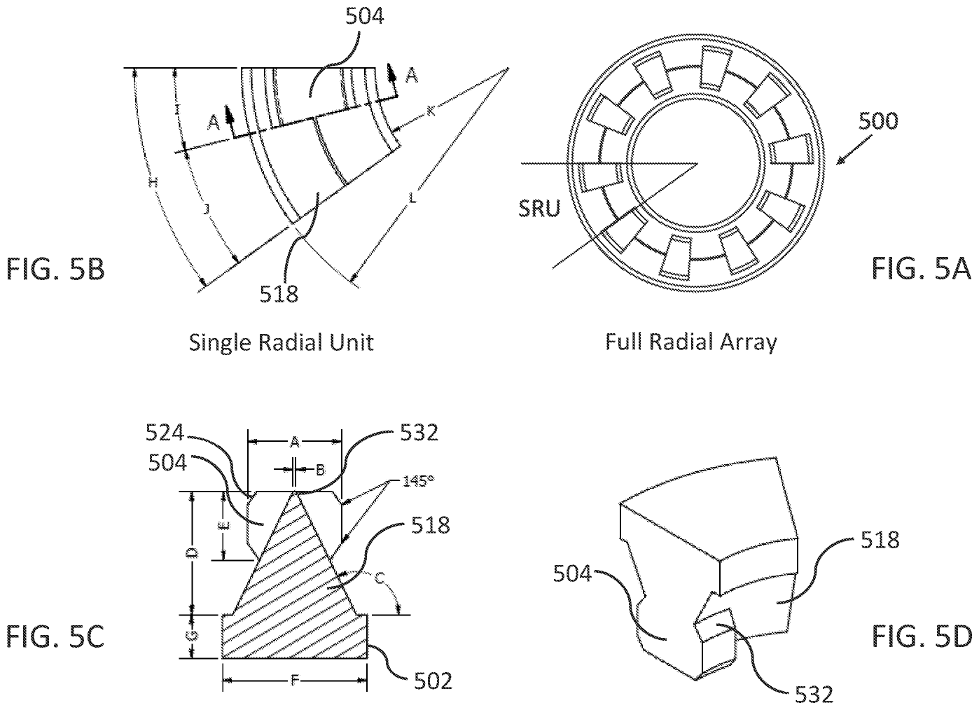

According to various embodiments, components of the connector assembly are of any size, and the components are scalable. Example 1 is an embodiment of a male connector illustrated in FIG. 5A-5C. Shown in FIG. 5A, a full radial array of a male connector 500 has ten “radial units” or in other words, a single radial unit (SRU) multiplied 10×. In some embodiments, the male connector 500 is manufactured by 3D printing. In the embodiment of Example 1, the male connector 500 has the size and dimensions listed in Table 1, and the dimensions are scalable according to the Definitions. In Example 1, the Scalable Dimension (SD) is 10 mm, and the Number of Linear Units (NLU) is 1.

TABLE 1

| | | |
|---|---|---|
| NRU | Number of | 10 |
| | Radial Units | |
| NLU | Number of | 1 |
| | Linear Units | |
| UPC | Radial Units | 10 |
| | per Circle | |
| SD | Scalable | 10 mm |
| | Dimension | |
| A | SD * .65 | 6.5 mm |
| B | SD * .02 | .2 mm |
| C | 90° ≤ C ≤ | 116° |
| | 150° | |
| D | >SD * .5 | 8.5 mm |
| E | SD * .475 | 4.75 mm |
| F | >SD * .8 | 10 mm |
| G | >0 | 3 mm |
| H | 360°/NRU | 36° |
| I | H * .4 | 14.4 |
| J | H * .6 | 21.6 |
| K | >/=0 | 10 mm |
| L | (F * NLU) + K | 20 mm |

The SRU shown in FIG. 5B is one of ten radial units, and thus has an arc dimension H of 36° (360°/NRU). The male nub 504 has an arc dimension I of 14.4° (H×0.4) and the tapered protrusion 518 has an arc dimension J of 21.6° (H×0.6). In various embodiments, the male connector 500 has an annular shape with an inner radius K of greater than or equal to zero. In Example 1, the inner radius K is 10 mm. In various embodiments, the male connector has an outer radius L determined by the dimension F of the connector main body×NLU+K. In Example 1 the outer radius L is 20 mm.

In the cross-section through A-A shown in FIG. 5C, embodiments of the male nub 504 have a dimension A based on the SD×0.65 and a dimension E based on SD×0.475. In Example 1. A is 6.5 mm and E is 4.75 mm. According to various embodiments, the male connector 500 has male nubs 504 in which the corners 524 have been shaved at an angle. In Example 1, the angle is about 145°. FIG. 5D shows a perspective view of a SRU, according to an embodiment.

In various embodiments, the tapered protrusion 518 protruding from the connector main body 502 has a dimension D of greater than SD×0.5, which in Example 1 is 8.5 mm. The remainder of the connector main body 502 below the protrusion 518 has a dimension G of greater than zero, which in Example 1 is 3 mm. In various embodiments, the tapered protrusion 518 between the male nubs 504 tapers at an angle C in a range of greater than or equal to 90° to less than or equal to 150°, which in Example 1 is 116°. The tapered protrusion 518 tapers to a point or flat end 522 having a dimension B that is SD×0.02, which in Example 1 is 0.2 mm.

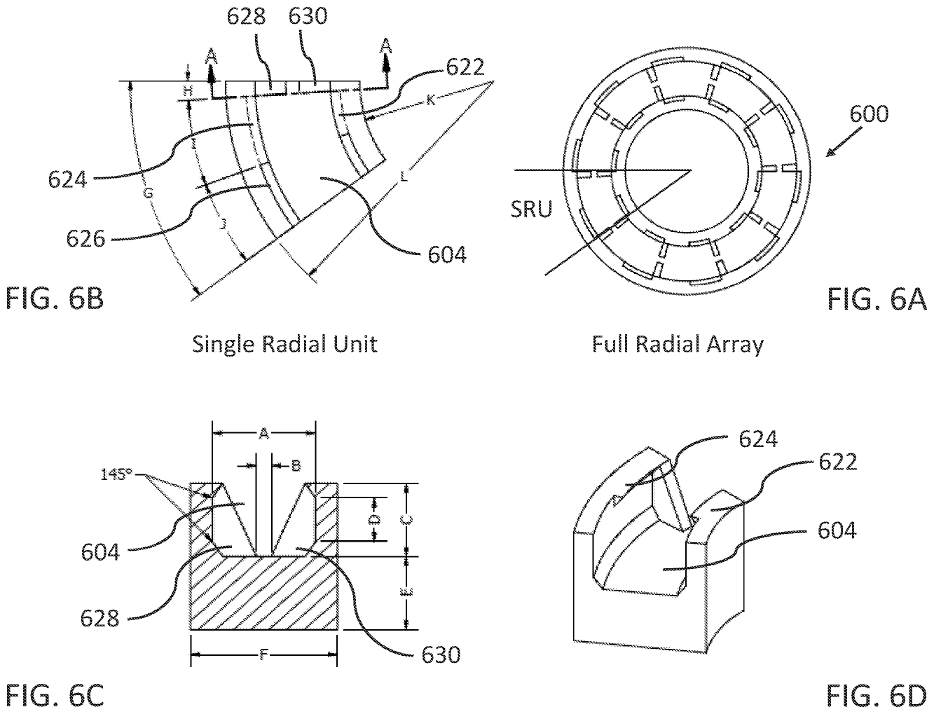

Example 2 is an embodiment of a female connector illustrated in FIG. 6A-6C. Shown in FIG. 6A, a full radial array of a female connector 600 has ten radial units or a SRU multiplied 10×. In some embodiments, the female connector 600 is manufactured by 3D printing. In the embodiment of Example 2, the female connector 600 has the size and dimensions listed in Table 2, and the dimensions are scalable according to the Definitions. In Example 2, the SD is 10 mm and the NLU is 1.

TABLE 2

| | | Sheet |
|---|---|---|
| Variable | Definition | Dimension |
| NRU | Number of | 10 |
| | Radial Units | |
| NLU | Number of | 1 |
| | Linear Units | |
| UPC | Radial Units | 10 |
| | per Circle | |
| SD | Scalable | 10 mm |
| | Dimension | |
| A | SD * .7 | 7 mm |
| B | SD * .1 | 1 mm |
| C | SD * .5 | 5 mm |
| D | SD * .3 | 3 mm |
| E | >0 | 5 mm |
| F | >SD * .8 | 10 mm |
| G | 360/NU | 36° |
| H | G * .1 | 3.6° |
| I | G * .45 | 16.2° |
| J | G * .45 | 16.2° |
| K | >/=0 | 10 mm |
| L | (F * NLU) + K | 20 mm |

The SRU shown in FIG. 6B is one of ten radial units, and thus has an arc dimension G of 36° (360°/NRU). In various embodiments, the female connector 600 has an annular shape with an inner radius K of greater than or equal to zero. In Example 2, the inner radius K is 10 mm. In various embodiments, the female connector has an outer radius L determined by the dimension F of the main body portion×NLU+K. In Example 2 the outer radius L is 20 mm.

In Example 2, the female slot 604 has an arc dimension I+J of 33.4°. The inner flange 622 and outer flange 624 that together cover a portion of the female slot 604 have an arc dimension I of 16.2°, and the receiving slot 626 has an arc dimension J of 16.2°. A remainder of the SRU includes the outer and inner stop barriers 628, 630, having an arc dimension H of 3.6°.

In the cross-section through A-A shown in FIG. 6C, embodiments of the female slot 604 have a dimension A based on the SD×0.7 and a dimension C based on SD×0.5. In embodiments, the female slot 604 is configured with corners having an angle that is not 90°. In Example 2, the angle is 145°, providing the female slot 604 with a dimension D. In Example 2, A is 7 mm, C is 5 mm, and D is 3 mm. In embodiments, the outer and inner stop barriers 628, 630 are positioned in the female slot 604 with a gap of dimension B. In Example 2, B is 1 mm.

According to various embodiments of the connector assembly, the male connector and female connector are configured to be connectable to each other. In various embodiments, the size, position, and dimensions of the elements that make up the male and female connectors are configured to engage in a manner that allows easy connection. In this regard, by way of example, the embodiments described in Example 1 and Example 2 include male and female connectors with elements that engage during connection having dimensions that allow a gap between corresponding engaging elements. For instance, dimension A in the female slot 604 is 7 mm and corresponding dimension A of the male nub 504 is 6.5 mm, providing a difference of 0.5 mm between these elements. Dimension C of the female slot 604 is 5 mm and corresponding dimension E of the male nub is 4.75 mm, providing a difference of 0.25 between these elements. Dimension B of female slot 604 is 1 mm and corresponding dimension B of male nub 104 is 0.2 mm.

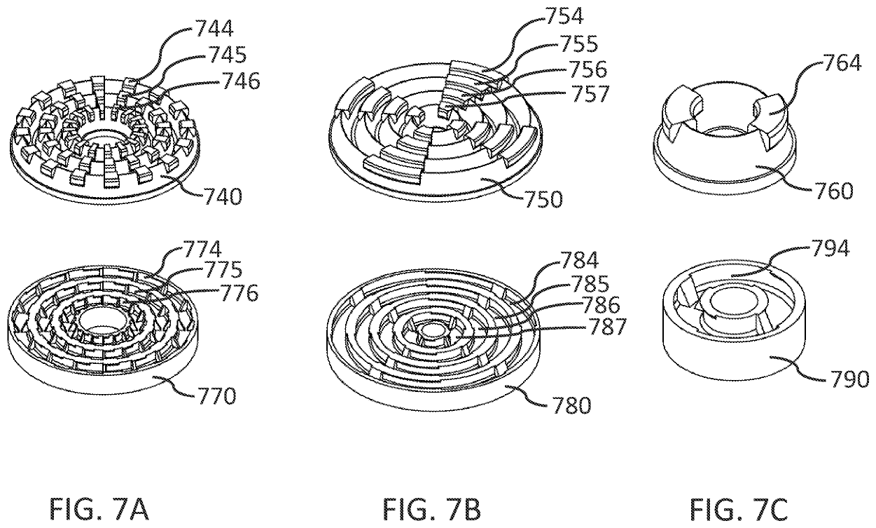

According to various embodiments, components of the connector assembly are of any size and are scalable. In various embodiments, the male connector and the female connector have various dimensions and various arrangements of male nubs and female slots. According to an embodiment shown in FIG. 7A, the male connector 740 has three sets of sixteen radial units: a first set of male nubs 744, a second set of male nubs 745, and a third set of male nubs 746. The male connector 740 has an inner radius, corresponding to inner radius K in FIG. 5B, of 10 mm, and an outer radius, corresponding to outer radius L in FIG. 5B, of 40 mm. The female connector 770 has three sets of sixteen radial units: a first set of female slots 774, a second set of female slots 775, and a third set of female slots 776. The female connector 770 has an inner radius, corresponding to inner radius K in FIG. 6B, of 10 mm, and an outer radius, corresponding to outer radius L in FIG. 6B, of 40 mm.

According to an embodiment shown in FIG. 7B, the male connector 750 has four sets of four radial units: a first set of male nubs 754, a second set of male nubs 755, a third set of male nubs 756, and a fourth set of male nubs 757. The male connector 750 has an inner radius, corresponding to inner radius K in FIG. 5B, of 5 mm, and an outer radius, corresponding to outer radius L in FIG. 5B, of 45 mm. The female connector 770 has four sets of four radial units: a first set of female slots 784, a second set of female slots 785, a third set of female slots 786, and a fourth set of slots 787. The female connector 780 has an inner radius, corresponding to inner radius K in FIG. 6B, of 5 mm, and an outer radius, corresponding to outer radius L in FIG. 6B, of 45 mm.

According to an embodiment shown in FIG. 7C, the male connector 760 has a single set of two radial units: one set of male nubs 764. The male connector 760 has an inner radius, corresponding to inner radius K in FIG. 5B, of 5 mm, and an outer radius, corresponding to outer radius L in FIG. 5B, of 15 mm. The female connector 790 has a single set of two radial units: one set of female slots 794. The female connector 790 has an inner radius, corresponding to inner radius K in FIG. 6B, of 5 mm, and an outer radius, corresponding to outer radius L in FIG. 6B, of 15 mm.

According to various embodiments, components of the connector assembly are manufactured from plastics, metals, or composites. In various embodiments, the male and/or female connector is made of one or more of nylon, ABS (Acrylonitrile Butadiene Styrene), PET (Polyethylene Terephthalate), PLA (Polylactic Acid), PVA (Polyvinyl Alcohol Plastic), HIPS (High Impact Polystyrene), resin, stainless steel, titanium, ceramics, or any combination thereof. In various embodiments, components of the connector assembly are manufactured by 3-D printing.

According to various embodiments of the present disclosure, the connector assembly is used in conjunction with structural elements or building components for use in building a structure. Various embodiments include a pair of building components that includes a first building component having a male connector, the male connector having a plurality of male nubs arranged in a circular manner, each male nub configured to be received by a corresponding female slot, and a second building component having a female connector, the female connector having a plurality of female slots arranged in a circular manner, each female slot configured to receive a corresponding male nub. The male connector and female connector are configured such that when the male connector is connected to the female connector, the plurality of male nubs engages with respective ones of the plurality of female slots, thereby connecting the pair of building components.

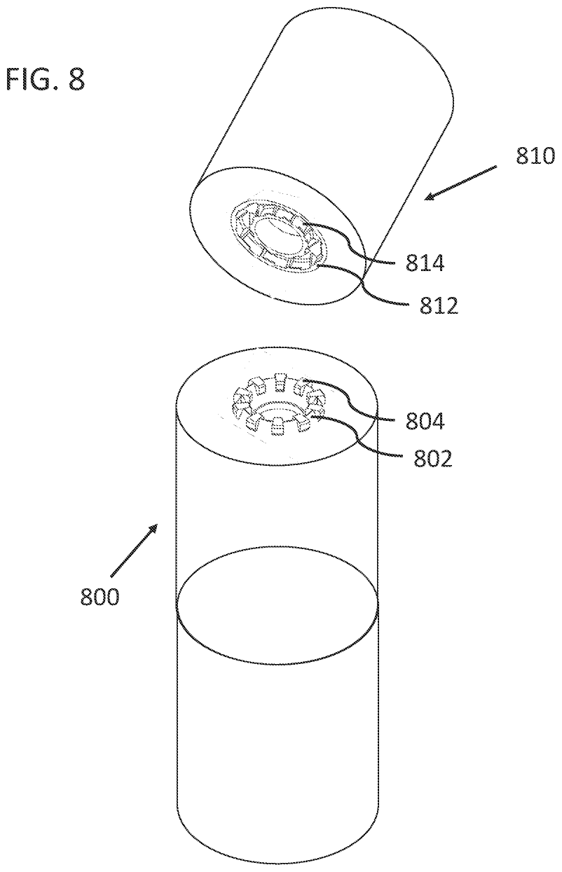

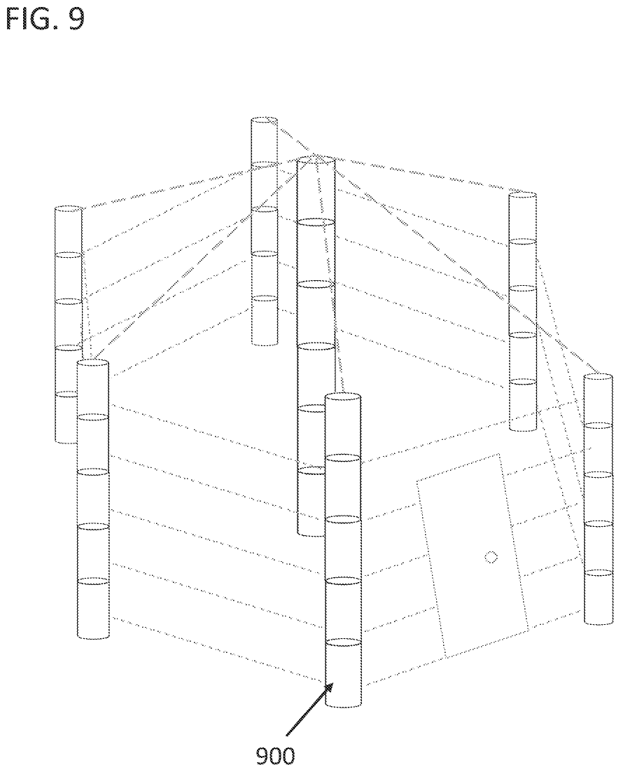

As illustrated in FIG. 8, various embodiments include a pair of building components that include a first building component 800 containing an integrally formed male connector 802, the male connector having a plurality of male nubs arranged in a circular manner 804, each male nub 804 configured to be received by a corresponding female slot, and a second building component 810 containing an integrally formed female connector 812, the female connector 812 having a plurality of female slots 814 arranged in a circular manner, each female slot 814 configured to receive a corresponding male nub 804. In various embodiments, the male connector 802 and female connector 812 are configured such that when the male connector 802 is connected to the female connector 812, the plurality of male nubs 804 engages with respective ones of the plurality of female slots 814, thereby interconnecting the pair of building components 800, 810.

In various embodiments, a building component has a male connector 802 at one end of the component and a female connector 812 at an opposite end of the component. In other embodiments, the building component has a male connector 802 or a female connector 812 at an end of the component.

According to various embodiments, one or more of the male connector and female connector are integrally formed with the building components. In other embodiments, the male connector and/or female connector are added as separate components to the structural element or building component. In other embodiments, one or more of the male connector and female connector are components of a separate connector component configured to engage with a portion of the building component. In some embodiments, one or more of the male connector and female connector are components of a connector sleeve having a hollow portion with an opening and an interior surface configured to slide over and conformingly receive an end of a building component. In alternative embodiments, the connector sleeve has an exterior surface configured to slide into and conformingly receive an end of a building component.

In some embodiments, the interior surface and/or exterior surface of the connector sleeve includes threads configured to engage with corresponding threads on an exterior surface and/or interior surface at the end of the building component, and the connector sleeve with the male or female connector is screwed on to the end of the building component. In other embodiments, the connector sleeve is configured to engage with the end of the building component by a friction fit.

According to various embodiments, the connector assembly provides a construction joint for use in assembling various building components, structural elements, or the like. Embodiments of the construction joint include a male connector and a female connector. The male connector includes a connector main body having an annular shape and a plurality of male nubs arranged circumferentially around the connector main body, each male nub configured to be received by a corresponding female slot. The female connector includes a main body portion having an annular shape and a plurality of female slots arranged circumferentially around the main body portion, each female slot configured to receive a corresponding male nub. The male connector and female connector are configured such that when the male connector is connected to the female connector, the plurality of male nubs engages with respective ones of the plurality of female slots, thereby providing a construction joint between building components.

As illustrated in FIG. 9, various embodiments of the building components 800 and 810 are linked together, through the connector assembly, to form a vertical structural element 900. In FIG. 9, embodiments of the building components 800 and 810 are columnar or substantially columnar. In some embodiments, the building components have a circular cross-section, a rectangular cross-section, or any shape cross-section. In embodiments, the building components are installed in various orientations and configurations. Various embodiments of the building components form a vertical structural element, such as a vertical frame member, a horizontal structural element, such as a horizontal frame member, or any orientation structural element.

Embodiments of the connector assembly are used to quickly align and interconnect two or more building components, e.g., during erection of prefabricated or component housing or other component structures. Embodiments of the connector assembly are also used to disconnect the building components quickly and handily.

As many changes can be made to the various embodiments without departing from the scope thereof, it is intended that all matter contained herein be considered illustrative and not in a limiting sense. In view of the many possible embodiments to which the principles of the present disclosure may be applied, it should be recognized that the illustrated embodiments are only examples of the present disclosure and should not be taken as limiting the scope of this disclosure. Rather the scope of the present disclosure is defined in part by the following claims.

What is claimed is:

1. A connector assembly, comprising a male connector and a female connector that are connectable to each other,
the male connector comprising:
a connector main body having an annular shape; and
a plurality of male nubs arranged circumferentially around the connector main body, each male nub configured to be received by a corresponding female slot,
the female connector comprising:
a main body portion having an annular shape; and
a plurality of female slots arranged circumferentially around the main body portion, each female slot configured to receive a corresponding male nub,
the male connector and female connector configured such that when the male connector is connected to the female connector, the plurality of male nubs engages with respective ones of the plurality of female slots.

2. The connector assembly of claim 1, the male connector comprising four or more male nubs.

3. The connector assembly of claim 1, the male connector comprising ten or more male nubs.

4. The connector assembly of claim 1,
the male connector comprising a first set of male nubs arranged circumferentially around the connector main body at a first radius, and a second set of male nubs arranged circumferentially around the connector main body at a second radius that is different than the first radius,
the female connector comprising a first set of female slots arranged circumferentially around the main body portion at a first radius, and a second set of female slots arranged circumferentially around the main body portion at a second radius that is different than the first radius.

5. The connector assembly of claim 1, at least one of the connector main body of the male connector and the main body portion of the female connector comprising an inner hole that is a through-hole.

6. The connector assembly of claim 1, the male nubs having a planar top surface.

7. The connector assembly of claim 1, the male nubs having a planar top surface and a trapezoidal shape along the planar top surface.

8. The connector assembly of claim 1, the male nubs arranged circumferentially around the connector main body are each separated by a substantially equal distance from one another.

9. The connector assembly of claim 1, the connector main body of the male connector having a tapered protrusion protruding from a top surface of the connector main body, the tapered protrusion connecting to the plurality of male nubs.

10. The connector assembly of claim 9, each female slot configured to receive at least a portion of the tapered protrusion.

11. The connector assembly of claim 1, further comprising a locking mechanism configured to fix the male connector to the female connector, the locking mechanism comprising:
a plurality of inner flanges arranged circumferentially around an inner circumference of the main body portion of the female connector; and
a plurality of corresponding outer flanges arranged circumferentially around an outer circumference of the main body portion of the female connector;
the inner flange and outer flange together covering a portion of the female slot but leaving the female slot with a receiving slot that is open and configured to receive the male nub,
the locking mechanism configured such that when the male connector is connected to the female connector by engaging the male nubs with the receiving slots, and rotating the male connector with respect to the female connector, the male nubs slide under and are held in place by the inner flange and outer flange, engaging the locking mechanism and thereby fixing the male connector to the female connector.

12. The connector assembly of claim 11, the female connector further comprising one or more stop barrier, the stop barrier positioned in the female slot in proximity to an end of the outer flange distal to the receiving slot, and/or in proximity to an end of the inner flange distal to the receiving slot, the one or more stop barrier configured to engage with one or more male nub and stop the rotating of the male connector at a location where the male nub is under and held in place by the inner flange and outer flange.

13. A male connector that is connectable to a female connector that comprises a main body portion having an annular shape and a plurality of female slots arranged circumferentially around the main body portion, each female slot configured to receive a corresponding male nub, the male connector comprising:
a connector main body having an annular shape; and
a plurality of male nubs arranged circumferentially around the connector main body, each male nub configured to be received by a corresponding female slot,
the male connector configured such that when the male connector is connected to the female connector, the plurality of male nubs engages with respective ones of the plurality of female slots.

14. The male connector of claim 13, comprising a first set of male nubs arranged circumferentially around the connector main body at a first radius, and a second set of male nubs arranged circumferentially around the connector main body at a second radius that is different than the first radius.

15. A female connector that is connectable to a male connector that comprises a connector main body having an annular shape and a plurality of male nubs arranged circumferentially around the connector main body, each male nub configured to be received by a corresponding female slot, the female connector comprising:
a main body portion having an annular shape; and
a plurality of female slots arranged circumferentially around the main body portion, each female slot configured to receive a corresponding male nub,
the female connector configured such that when the female connector is connected to the male connector, the plurality of male nubs engages with respective ones of the plurality of female slots.

16. The female connector of claim 15, further comprising
a plurality of inner flanges arranged circumferentially around an inner ring circumference of the annular main body portion of the female connector; and
a plurality of corresponding outer flanges arranged circumferentially around an outer ring circumference of the annular main body portion of the female connector;
the inner flange and outer flange together covering a portion of the female slot but leaving the female slot with a receiving slot that is open and configured to receive the male nub,
the inner flange and outer flange together forming a locking mechanism configured such that when the male connector is connected to the female connector by engaging the male nubs with the receiving slots, and rotating the male connector with respect to the female connector, the male nubs slide under and are held in place by the inner flange and outer flange, engaging the locking mechanism and thereby fixing the male connector to the female connector.

17. The female connector of claim 16, further comprising one or more stop barrier, the stop barrier positioned in the female slot in proximity to an end of the outer flange distal to the receiving slot, and/or in proximity to an end of the inner flange distal to the receiving slot, the one or more stop barrier configured to engage with one or more male nub and stop the rotating of the male connector at a location where the male nub is under and held in place by the inner flange and outer flange.

18. A pair of building components for use in building a structure, the pair of building components comprising:
a first building component comprising a male connector, the male connector comprising a plurality of male nubs arranged in a circular manner, each male nub configured to be received by a corresponding female slot; and
a second building component comprising a female connector, the female connector comprising a plurality of female slots arranged in a circular manner, each female slot configured to receive a corresponding male nub,
the male connector and female connector configured such that when the male connector is connected to the female connector, the plurality of male nubs engages with respective ones of the plurality of female slots, thereby connecting the pair of building components.

19. The pair of building components of claim 18, the male connector and female connector being integrally formed with building component.

20. The pair of building components of claim 18, the components having the male connector at one end of the component and a female connector at an opposite end of the component.
